(19) United States
(12) Patent Application Publication
(10) Pub. No.: US 2024/0408489 A1
(43) Pub. Date: Dec. 12, 2024

(54) COMPUTER-READABLE NON-TRANSITORY STORAGE MEDIUM HAVING GAME PROGRAM STORED THEREIN, GAME PROCESSING METHOD, AND GAME SYSTEM

(71) Applicant: NINTENDO CO., LTD., Kyoto (JP)

(72) Inventors: Ryuhei MATSUURA, Kyoto (JP); Mai YAMAMOTO, Kyoto (JP); Ryota IRIE, Kyoto (JP); Shigeyuki ASUKE, Kyoto (JP); Hajime NAKAO, Kyoto (JP)

(21) Appl. No.: 18/620,354

(22) Filed: Mar. 28, 2024

(30) Foreign Application Priority Data
Jun. 8, 2023 (JP) 2023-094866

(51) Int. Cl. A63F 13/5252; A63F 13/422

(52) U.S. Cl. CPC A63F 13/5252; A63F 13/422

(57) ABSTRACT

A first player object is moved through an operation input by a player. When a second player object operated by another player is present outside a range of a game image, a 2P icon indicating the second player object is displayed at a position that is in the game image and according to a position of the second player object. When the second player object is in a first state, if the position of the second player object is within a predetermined distance from the first player object, a state icon indicating the first state is displayed instead of or in addition to the 2P icon, and if the position of the second object is at the predetermined distance or farther, the 2P icon is displayed and the state icon is not displayed.

### CROSS REFERENCE TO RELATED APPLICATION

This application claims priority to Japanese Patent Application No. 2023-094866 filed on Jun. 8, 2023, the entire contents of which are incorporated herein by reference.

### FIELD

The present disclosure relates to display control for information about a player character present outside a screen.

### BACKGROUND AND SUMMARY

Conventionally, there has been known a technology in which, when a player object satisfying a predetermined condition is present outside a display range, a position mark indicating the position of the player object is displayed.

In games as described above, there is a possibility that a player cannot concentrate on his/her game play because a notice that the predetermined condition is satisfied is always displayed. Meanwhile, without such a position mark as described above, there is a possibility that a player comes to no longer know presence of another player object or the position thereof.

Configuration examples for achieving the above object will be shown below.

### (Configuration 1)

Configuration 1 is one or more computer-readable non-transitory storage media having stored therein a game program that causes one or more processors of one or more information processing apparatuses to: move a first player object in a virtual space in accordance with an operation input by a player; control a virtual camera for generating a game image, in association with a position of the first player object; when a second player object operated by another player is present at a position outside a range of the game image in the virtual space, generate a 2P icon indicating the second player object so that the 2P icon is displayed at a position that is in the game image and according to the position of the second player object; and in generating the 2P icon, when the second player object is in a first state, (1) if a distance to the position of the second player object from a reference position for the first player object is less than a predetermined distance, generate, instead of the 2P icon or in addition to the 2P icon, a state icon indicating the first state so that the state icon is displayed at a position that is in the game image and according to the position of the second player object, and (2) if the distance to the position of the second player object is not less than the predetermined distance, generate the 2P icon so that the 2P icon is displayed in the game image without generating the state icon.

According to the above configuration, when the second player object present outside the screen has come into the first state, if the second player object is at a position closer than the predetermined distance from the first player object, the player finds that the second player object is in the first state. Therefore, the player can advance the game in accordance with the position and the state of the second player object. On the other hand, if the second player object is at a position farther than the predetermined distance, the player cannot be notified about the fact that the second player object is in the first state. Therefore, while the player recognizes that the second player object is present and recognizes the position thereof, the player is not notified about information such as the first state more than necessary and thus amusement of the game is prevented from being lowered by the player being notified of such information more than necessary.

### (Configuration 2)

In configuration 2 based on the above configuration 1, the first state may continue for a predetermined period and may be such a state that a predetermined in-game effect will be exerted by the first player object and the second player object coming close to each other while the first state is continuing.

According to the above configuration, in exerting or not exerting a predetermined in-game effect, the player can recognize that the second player object is in the first state, whereby amusement of the game can be improved. On the other hand, in a case where the second player object is at a far position to a certain extent, information about whether or not the second player object is in the first state is not displayed, so that the player can concentrate on his/her game operation.

### (Configuration 3)

In configuration 3 based on the above configuration 1, the in-game effect may be an effect of allowing the second player object to advance the game advantageously.

It is assumed that the player has attempted to bring the first player object close to the second player object in order to exert an in-game effect but the in-game effect cannot be exerted because the distance to the second player object is long. In this case, amusement of the game is lowered. However, according to the above configuration, in a case where the second player object is at the predetermined distance or farther, information about whether or not the second player object is in the first state is not displayed, and thus amusement of the game is not lowered. On the other hand, if information that the second player object is in the first state is displayed, this means that the second player object is present at a close position to a certain extent, thus providing a motivation to bring the first player object close to the second player object in order to exert an in-game effect.

### (Configuration 4)

In configuration 4 based on the above configuration 3, the first state may be such a state that will end up in game over or interrupt play to restart play, when the predetermined period elapses, and the in-game effect may be an effect of allowing the play to be continued.

According to the above configuration, it is possible to enhance a motivation to exert an in-game effect within the predetermined period.

### (Configuration 5)

In configuration 5 based on any one of the above configurations 1 to 4, the predetermined distance may be less than a distance that the first player object can travel when continuously moving during the predetermined period.

According to the above configuration, it is possible to prevent amusement of the game from being lowered due to the state icon being displayed in such a situation that a predetermined in-game effect will not be exerted or will be hard to be exerted.

### (Configuration 6)

In configuration 6 based on any one of the above configurations 2 to 5, the state icon may include information regarding a remaining time until the predetermined period elapses for the second player object.

According to the above configuration, the remaining time of the time limit is displayed to enhance the sense of tension of the player, whereby amusement of the game can be improved.

### (Configuration 7)

In configuration 7 based on any one of the above configurations 2 to 6, the state icon may include information regarding a distance to the position of the second player object.

According to the above configuration, it is possible to recognize the distance to the second player object more specifically, whereby convenience for the player can be improved.

### (Configuration 8)

In configuration 8 based on any one of the above configurations 2 to 7, the game program may cause the one or more processors to, when the first player object is in the first state, generate, instead of the 2P icon or in addition to the 2P icon, distance information to the position of the second player object so that the distance information is displayed in the game image.

According to the above configuration, it becomes easy for each player to recognize in which direction and how far another player object is away from the own player object.

### (Configuration 9)

In configuration 9 based on any one of the above configurations 2 to 8, the game program may cause the one or more processors to perform control such that in a case of not exceeding the predetermined distance, the 2P icon is reduced as a distance between the first player object and the second player object becomes longer, and in a case of exceeding the predetermined distance, the 2P icon has a constant size irrespective of the distance between the first player object and the second player object.

According to the above configuration, when the second player object is in the first state, the distance thereto can be perceived to a certain extent by the size of the icon, whereby it becomes easy to determine whether or not to approach the second player object.

### (Configuration 10)

In configuration 10 based on any one of the above configurations 2 to 8, the game program may cause the one or more processors to change a display manner of the 2P icon when a distance between the first player object and the second player object becomes greater than the predetermined distance.

According to the above configuration, it becomes easy for the player to understand such a situation that whether or not the second player object is in the first state is not displayed.

### (Configuration 11)

In configuration 11 based on any one of the above configurations 1 to 10, the game program may cause the one or more processors to, when the second player object is in a second state, generate, instead of the 2P icon or in addition to the 2P icon, a specific state icon indicating the second state so that the specific state icon is displayed in the game image, irrespective of a distance between the first player object and the second player object.

According to the above configuration, for example, information about a specific state which is important to the player is always displayed irrespective of the distance, and regarding information about a state whose importance is lowered depending on the distance, display therefor is switched in accordance with the distance, whereby comfortable game play is achieved.

### (Configuration 12)

In configuration 12 based on the above configuration 11, the second state may be such a state that the second player object disappears from the virtual space.

For example, in a case where the second player object (other player) has disappeared from the virtual space, it is difficult to notify the player of that fact merely by deleting the 2P icon. However, according to the above configuration, it is possible to clearly notify the player, as compared to the case of merely deleting the 2P icon.

### (Configuration 13)

In configuration 13 based on the above configuration 1, the game program may cause the one or more processors to change the second player object into the first state when the second player object acquires a predetermined item placed in the virtual space.

According to the above configuration, the player can recognize that the second player object has changed into the first state, and with this fact, the player can recognize that a predetermined item is present near the first player object.

### (Configuration 14)

In configuration 14 based on the above configuration 1, the virtual space may include an area where the second player object can move when being in the first state.

According to the above configuration, it is possible to let the player recognize that there is a place that a player object cannot reach unless changing into the first state, through display of the 2P icon and the state icon.

### (Configuration 15)

In configuration 15 based on any one of the above configurations 1 to 14, the game may be such a game that the first player object is moved in a virtual course including a first virtual space and a second virtual space which are not continuously connected to each other, and the game program may cause the one or more processors to, when the first player object is in the first virtual space and the second player object is in the second virtual space, generate the 2P icon so that the 2P icon is displayed at a position that is in a game image for the first virtual space and that is according to a position of the second player object in the second virtual space.

According to the above configuration, even in a case where player objects are present in different virtual spaces that are not connected to each other, it is possible to let the players feel as if the player objects are present in the same virtual space.

### (Configuration 16)

In configuration 16 based on the above configuration 15, the game may be such a game that the game image is displayed such that the virtual space is side-scrolled or vertically scrolled. A first predetermined range extending in a left-right direction or an up-down direction in the first virtual space, and a second predetermined range extending in a left-right direction or an up-down direction in the second virtual space, may be set as associated ranges in advance. The game program may cause the one or more processors to, when the second player object is present at a position included in the second predetermined range in the left-right direction or the up-down direction, generate the 2P icon so that the 2P icon is displayed at a position that is in the game image for the first virtual space and that is according to a position in the first predetermined range corresponding to a position in the second predetermined range based on the position of the second player object.

### (Configuration 17)

In configuration 17 based on the above configuration 15, a relationship for associating a position in the second virtual space with a position in the first virtual space may be set in advance, and the game program may cause the one or more processors to associate a position of the second player object in the second virtual space with a position in the first virtual space on the basis of the relationship, and generate the 2P icon so that the 2P icon is displayed at a position that is in the game image and according to the associated position in the first virtual space.

According to the above configuration, the 2P icon is displayed at a predetermined position in accordance with movement of the second player object present in another virtual space, whereby it is possible to let the player feel as if both player objects are present in the same world.

### (Configuration 18)

In configuration 18 based on the above configuration 15, the game program may cause the one or more processors to, when the first player object and the second player object are present in different spaces, generate the 2P icon without generating the state icon even if the second player is in the first state.

According to the above configuration, the player can easily understand that the second player object is present in a virtual space different from that for the first player object.

According to the present disclosure, it is possible to select whether or not to display the fact of being in the first state, on the basis of the distance to another player object present outside the screen. Thus, while amusement of the game is prevented from being lowered, the player can comfortably advance the game with reference to the direction where the second player object is present and the state thereof.

### BRIEF DESCRIPTION OF THE DRAWINGS

FIG. 1 is a schematic diagram showing a non-limiting example of the entire configuration of a game system according to this exemplary embodiment;

FIG. 2 is a block diagram showing a non-limiting example of a hardware configuration of a game server 1;

FIG. 3 is a block diagram showing a non-limiting example of a hardware configuration of a game apparatus 3;

FIG. 4 shows a non-limiting example of a game screen;

FIG. 5 is a schematic view showing a non-limiting example of a positional relationship of player characters;

FIG. 6 is a schematic view showing a non-limiting example of a positional relationship of player characters;

FIG. 7 shows a non-limiting example of a game screen;

FIG. 8 shows a non-limiting example of a stage screen;

FIG. 9 shows a non-limiting example of a game screen;

FIG. 10 is an enlarged view showing a non-limiting example of a 2P icon 211;

FIG. 11 is a schematic view showing a non-limiting example of a positional relationship of player characters;

FIG. 12 shows a non-limiting example of a game screen;

FIG. 13 illustrates a non-limiting example of a relationship between the size of the 2P icon 211 and a distance from a 1P character 201;

FIG. 14 is a schematic view showing a non-limiting example of a positional relationship of player characters;

FIG. 15 shows a non-limiting example of a game screen;

FIG. 16 is an enlarged view showing a non-limiting example of a state icon 212;

FIG. 17 shows a non-limiting example of display of a marker;

FIG. 18 shows a schematic view showing a non-limiting example of a positional relationship of player characters;

FIG. 19 shows a non-limiting example of a game screen;

FIG. 20 shows a non-limiting example of a game screen;

FIG. 21 is an enlarged view showing a non-limiting example of the 2P icon 211;

FIG. 22 is a memory map showing a non-limiting example of various data stored in a storage unit 32 of the game apparatus 3;

FIG. 23 is a non-limiting example of a flowchart showing the details of game processing executed by the game apparatus 3;

FIG. 24 shows a non-limiting example of a course having a plurality of areas;

FIG. 25 illustrates a non-limiting example of a link range;

FIG. 26 is a schematic view showing a non-limiting example of a positional relationship of player characters;

FIG. 27 shows a non-limiting example of a game screen;

FIG. 28 is a schematic view showing a non-limiting example of a positional relationship of player characters;

FIG. 29 shows a non-limiting example of a game screen;

FIG. 30 shows a non-limiting example of a course having a plurality of areas;

FIG. 31 illustrates a non-limiting example of a link range;

FIG. 32 is a schematic view showing a non-limiting example of a positional relationship between player characters;

FIG. 33 shows a non-limiting example of a game screen;

FIG. 34 shows a non-limiting example of a game screen; and

FIG. 35 shows a non-limiting example of a course having a plurality of areas.

### DETAILED DESCRIPTION OF NON-LIMITING EXAMPLE EMBODIMENTS

Hereinafter, one exemplary embodiment of the present disclosure will be described. FIG. 1 is a schematic diagram showing the entire configuration of an information processing system (game system) according to the exemplary embodiment. An information processing system 100 of the exemplary embodiment includes a game server 1 and a plurality of information processing terminals 3. The game server 1 and each information processing terminal 3 are configured to be able to communicate with each other via a network 10 such as the Internet. In the exemplary embodiment, with such a configuration, information processing is executed. Hereinafter, a description will be given with game processing as an example of the information processing. Specifically, it is assumed as an example that a game program is installed on the information processing terminal 3 and the game processing is executed while the information processing terminal 3 is communicating with the game server 1 or another information processing terminal 3 as necessary.

### [Hardware Configuration of Game Server]

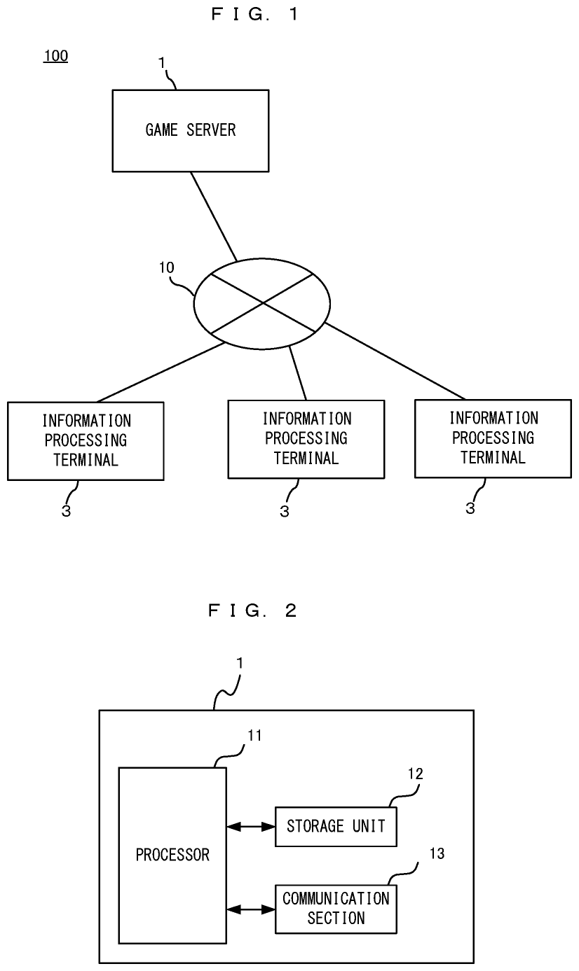

Next, the hardware configuration of the game server 1 will be described. In the exemplary embodiment, FIG. 2 is a block diagram illustrating the hardware configuration of the game server 1. Hereinafter, the game server 1 may be simply referred to as a server. The server 1 includes at least a processor 11, a storage unit 12, and a communication section 13. The processor 11 executes various programs for controlling the server 1. In the storage unit 12, various programs to be executed by the processor 11 and various kinds of data to be used by the processor 11 are stored. The communication section 13 connects to a network by means of wired or wireless communication and transmits/receives predetermined data to/from each information processing terminal 3 or another server (not shown).

### [Hardware Configuration of Information Processing Terminal]

Next, the information processing terminal 3 will be described. The information processing terminal 3 is, for example, a smartphone, a stationary or hand-held game apparatus, a tablet terminal, a mobile phone, a personal computer, a wearable terminal, or the like. In the exemplary embodiment, a stationary game apparatus (hereinafter, referred to simply as a game apparatus) will be described as an example of the information processing terminal 3.

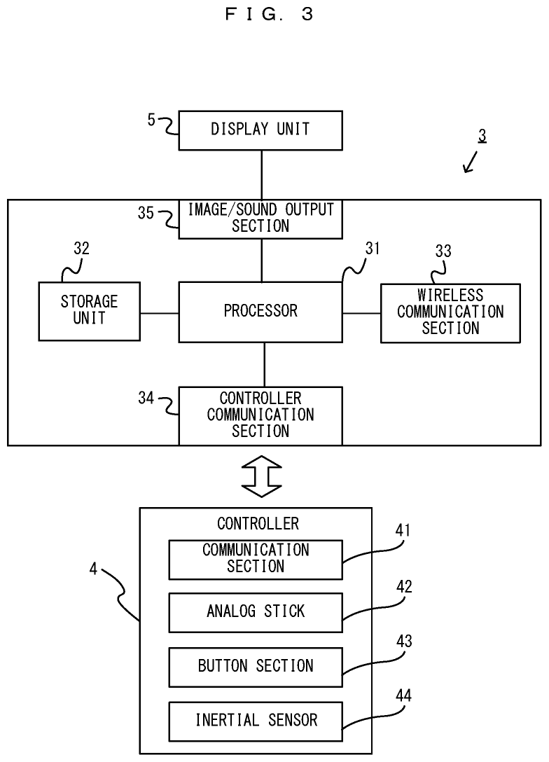

FIG. 3 is a block diagram showing an example of the hardware configuration of the game apparatus 3 according to the exemplary embodiment. In FIG. 3, the game apparatus 3 includes a processor 31. The processor 31 is an information processing section for executing various types of information processing to be executed by the game apparatus 3. For example, the processor 31 may be composed only of a CPU (Central Processing Unit), or may be composed of a SoC (System-on-a-chip) having a plurality of functions such as a CPU function and a GPU (Graphics Processing Unit) function. The processor 31 performs the various types of information processing by executing an information processing program (e.g., a game program) stored in a storage section 32. The storage section 32 may be, for example, an internal storage medium such as a flash memory and a dynamic random access memory (DRAM), or may be configured to utilize an external storage medium mounted to a slot that is not shown, or the like.

The game apparatus 3 also includes a wireless communication section 33 for the game apparatus 3 to perform wireless communication with another game apparatus 3 or the above server. As this wireless communication, for example, internet communication or short-range wireless communication is used.

The game apparatus 3 also includes a controller communication section 34 for the game apparatus 3 to perform wired or wireless communication with a controller 4.

Moreover, a display unit 5 (for example, a television or the like) is connected to the game apparatus 3 via an image/sound output section 35. The processor 31 outputs an image and sound generated (for example, by executing the above information processing) to the display unit 5 via the image/sound output section 35.

Next, the controller 4 will be described. The controller 4 includes at least one analog stick 42 which is an example of a direction input device. The analog stick 42 can be used as a direction input section with which a direction can be inputted. By tilting the analog stick 42, a player can input a direction corresponding to the tilt direction (also input a magnitude corresponding to the tilt angle). In addition, the controller 4 includes a button section 43 including various operation buttons. For example, the controller 4 may include a plurality of operation buttons on a main surface of the housing.

Moreover, the controller 4 includes an inertial sensor 44. Specifically, the controller 4 includes an acceleration sensor and an angular velocity sensor as the inertial sensor 44. In the exemplary embodiment, the acceleration sensor detects the magnitudes of accelerations along predetermined three axial directions. In addition, the angular velocity sensor detects angular velocities about predetermined three axes.

The controller 4 also includes a communication section 41 for performing wired or wireless communication with the controller communication section 34. The content of a direction input to the analog stick 42, information indicating the press state of the button section 43, and various detection results by the inertial sensor 44 are repeatedly outputted to the communication section 41 and transmitted to the game apparatus 3 at appropriate timings.

### First Exemplary Embodiment

Next, the outline of operation in information processing according to the first exemplary embodiment will be described. In this exemplary embodiment, as an example of the information processing, game processing with which a player plays by operating a player character object (hereinafter, referred to as a player character) present in a virtual space is assumed. More specifically, in this exemplary embodiment, a side-scrolling action game (hereinafter, referred to as this game) which advances on a 2D screen is assumed. In this game, a virtual space called a “course”, which serves as a main stage for playing, is prepared. The virtual space is, for example, a two-dimensional virtual space, and various kinds of objects are arranged in a horizontally-long area. In the course, a start point and a goal point are set. Between the start point and the goal point, various enemy characters, various obstacles, and various gimmicks such as a trampoline and a pit, are arranged. This game is such a game that a player character is operated to reach the goal point while defeating or avoiding enemy characters and the like. The course may be called a “stage”, a “round”, or the like, depending on games.

In this game, multiplay is possible. As an example, the game apparatus 3 is connected to the above server or another game apparatus 3 via the Internet, thus enabling online multiplay with another player. More specifically, in this game, online multiplay can be performed using a communication group configuration in an online game of a so-called MO (Multiplayer Online) type. That is, a communication group (hereinafter, referred to as a course room) corresponding to the course and a virtual space corresponding to the course are generated. Then, a predetermined number of players “enter” the virtual space, so that the players who have entered can perform online multiplay. For the stage room, a maximum value of the number of players that can enter the room is set. In this example, stage rooms are set such that a maximum of four players can enter one room. In this game, as an example, a configuration in which the game apparatuses 3 are connected to each other by communication means of P2P (Peer to peer) is used for the stage room.

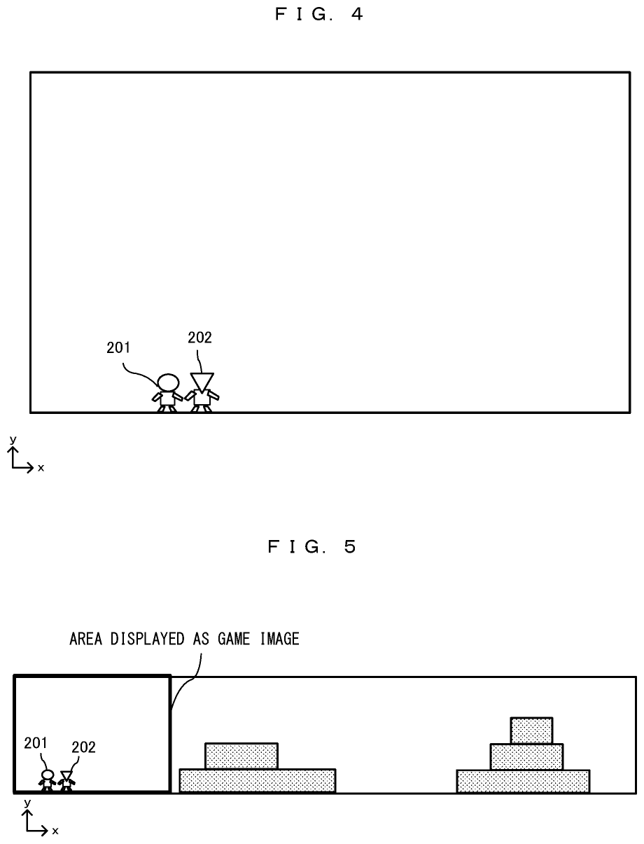

Hereinafter, a case where two players play this game will be described as an example. FIG. 4 shows an example of a game screen in this game. In FIG. 4, a 1P character 201 operated by a first player and a 2P character 202 operated by a second player are displayed. The game screen is a game screen on the game apparatus 3 of the first player, and the following description is based on the viewpoints of the first player and the game apparatus 3 of the first player. Here, coordinate axes of the game screen are defined such that the upward direction is a y-axis positive direction and the rightward direction is an x-axis positive direction.

In this game, the 2P character 202 moves with a second player's operation reflected, but does not directly interfere with and does not influence the content of game play executed on the game apparatus 3 of the first player. That is, game play of the first player is not hampered by the 2P character 202. Specifically, only position information of player characters of individual players is shared between the game apparatuses 3. On the other hand, the state, position information, and the like of the enemy characters and the like are not shared. For example, on the game apparatus 3 of the first player, collision detection processing with an enemy object or the like in the course is performed only for the 1P character 201 and collision detection processing for the 2P character 202 is not performed. Therefore, even if the 1P character 201 overlaps the position of the 2P character 202, the 1P character 201 ends up moving through the 2P character 202 without colliding therewith. In addition, also in a case where the 2P character 202 overlaps an enemy character, collision detection or the like between the 2P character 202 and the enemy character is not performed, and the enemy character ends up moving through the 2P character 202. In addition, for example, in a case where the 1P character 201 has defeated the enemy character A, the state of the enemy character A is not reflected in the game apparatus 3 of the second player. On the game apparatus 3 of the second player, if the second player has not defeated the enemy character A, control is performed such that the enemy character A is still present. That is, advancement management for play in the course is performed individually on the game apparatus of each player, and at this time, if the 2P character 202 is present in the same course room, control is performed such that the 2P character 202 is just displayed. Therefore, basically, each player can play in the course with a sense similar to single play without being influenced by the behavior of another player and without hampering the behavior of another player or doing anything like that.

### [Cooperative Feature]

As described above, each player can basically advance the game individually without being influenced from another player. However, this game has a feature like cooperative play as follows. Specifically, in this game, a player can influence or be influenced by another player through a function of “revival assistance”. The “revival assistance” will be described. For example, it is assumed that the 1P character 201 comes into contact with an enemy character and thus would end in a “loss” if the game is in a single play mode. The “loss” refers to a case where advancement of game play is interrupted, one life is lost, and play is started again (restart, respawn, etc.), or a case of resulting in game over if there are no lives, for example. Such a case is not immediately considered a “loss” if play is being performed in an online connected state. Instead, the outer appearance of the 1P character 201 is changed. Hereinafter, the character whose outer appearance has been changed is referred to as a “revival-waiting character”. In addition, the state of the player character before change to a revival-waiting character is referred to as a “normal state”, and the state of the player character that has been changed to a revival-waiting character is referred to as a “revival-waiting state”.

The revival-waiting character can be moved through operation by the first player. In addition, during the revival-waiting state, the revival-waiting character is not subjected to collision detection with an obstacle such as a terrain object and can pass therethrough. Further, during the revival-waiting state, the revival-waiting character does not take any damage from an enemy character or the like. Then, if the position of the 2P character 202 and the position of the revival-waiting character come close to each other before a predetermined period elapses, the 1P character 201 can be returned to a normal state. As an example, in appearance, it is possible to revive the 1P character 201 that has become a revival-waiting character by bringing both characters into contact with each other, without being considered a “loss”. The same applies to a case where the 1P character 201 and the 2P character 202 are in an opposite relationship. That is, for example, when the 2P character 202 comes into contact with an enemy character, the 2P character 202 becomes a revival-waiting character. Then, if the positions of the 1P character 201 and the 2P character 202 are successfully made to overlap each other within the predetermined period, the 2P character 202 can be revived. On the other hand, if the positions of both characters have failed to overlap each other within the predetermined period, a “loss” is made definite at this time so that a life is lost, resulting in restart or game over. Therefore, for example, if each player plays the game so that the player characters move while keeping a close distance to a certain extent, it becomes easy to assist revival of a revival-waiting character when an event that can lead to a “loss” has occurred. As a result, game over is less likely to occur, and thus it is possible to take advantage of play by multiple players. When the character (1P character 201) operated by the player has changed to a revival-waiting character, a count indication showing the remaining time of the predetermined period in which the revival is possible may be displayed at a predetermined position in the screen. For example, a remaining-time counter may be displayed at around a position under the revival-waiting character, so as to follow movement of the revival-waiting character. In addition, in order to revive the revival-waiting character, the revival-waiting character may not necessarily be brought into contact with another character. For example, the revival-waiting character may be revived at least when both characters come close to each other to such an extent that one character is displayed on the game screen of the player operating another character.

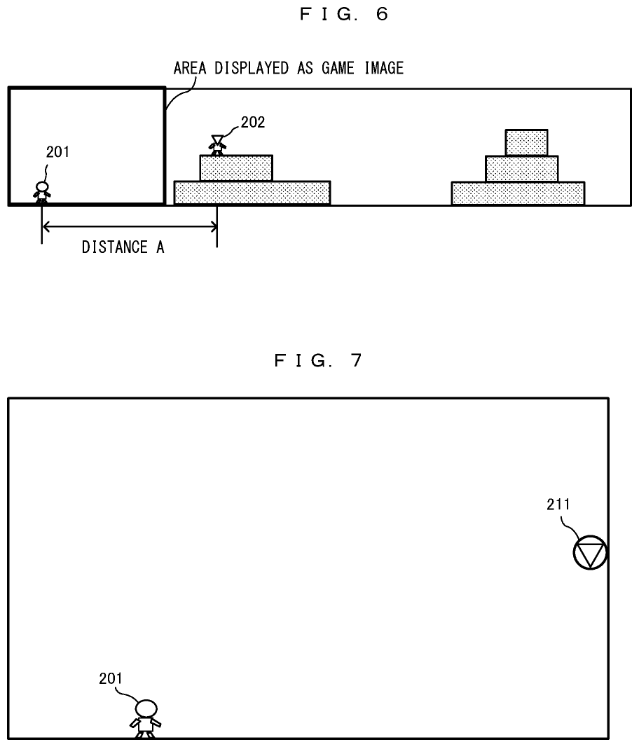

Meanwhile, as described above, since the game can be individually advanced on each game apparatus 3, the 1P character 201 and the 2P character 202 can come into such a positional relationship that they are not displayed in the same game screen. FIG. 5 is a schematic view showing a part of the course and the positional relationship between the 1P character 201 and the 2P character 202, in a case corresponding to the state in FIG. 4. In the following description, coordinate axes of the course (virtual space) are defined such that the upward direction is a y-axis positive direction and the rightward direction (direction toward the goal point) is an x-axis positive direction. FIG. 6 is a schematic view showing a positional relationship when only the 2P character 202 moves slightly ahead from the state in FIG. 5. In FIG. 6, the position of the 2P character 202 is such a position that the 2P character 202 is not displayed in the game screen on the game apparatus 3 of the first player.

In the situation as in FIG. 6, in order to allow the first player to recognize an approximate position (including a direction) where the 2P character 202 is present relative to the 1P character 201, in this game, a “marker” corresponding to the 2P character 202 is displayed near the right end or the left end of the game screen. In this example, either a “2P icon” or a “state icon” described below are displayed as the marker. In this example, it is assumed that two players are in the course room, but for example, in a case where four players are in the course room, markers corresponding to the respective players can be displayed. For example, on the game screen of the first player, a maximum of three markers corresponding to the respective player characters operated by the players (referred to as remote players) other than the first player can be displayed at the same time.

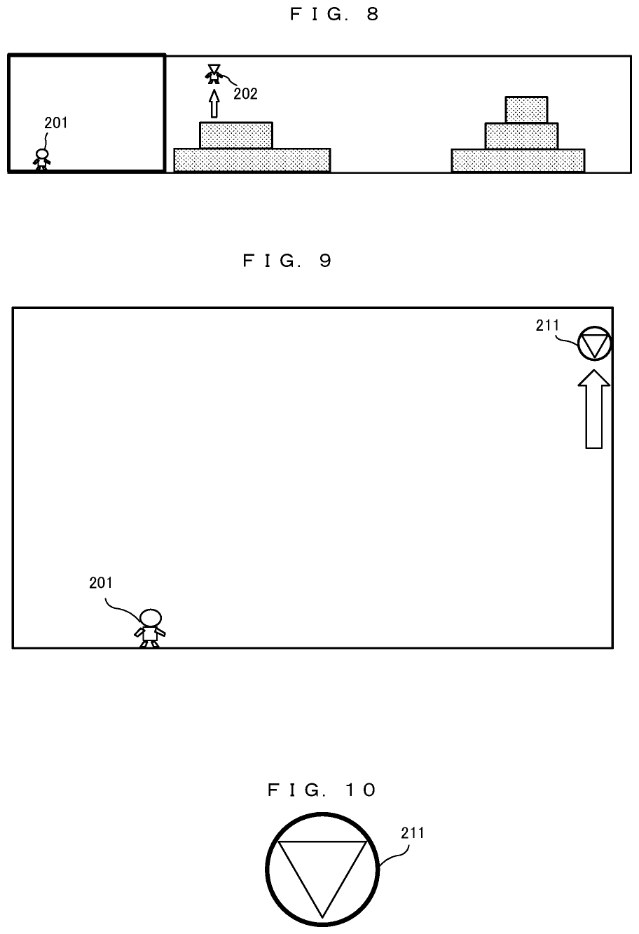

FIG. 7 shows an example of display of the marker on the game screen of the first player. In FIG. 7, a 2P icon 211 is displayed as a marker substantially in the vicinity of the center at the right end of the screen. In this drawing, the 2P character 202 is present at a position shifted rightward (toward the goal) by a distance A from the 1P character 201 as shown in FIG. 6, so that the 2P icon 211 is displayed at the right end of the screen. In a case where the 2P character 202 is located at a position leftward of the 1P character 201 and outside the screen, the 2P icon 211 is displayed at the left end of the game screen. The display position of the 2P icon 211 on the y axis of the game screen reflects the position (hereinafter, y-axis position) of the 2P character 202 on the y axis in the virtual space. For example, from the state in FIG. 6, in a case where the 2P character 202 jumps to slightly move upward as shown in FIG. 8, the display position of the 2P icon 211 also slightly moves vertically upward on the game screen of the first player while remaining at the right end of the screen, as shown in FIG. 9. In this way, by displaying the 2P icon 211, the first player can easily recognize whether the player character of the second player is present at a frontward position or a rearward position relative to the own player character, or whether the player character of the second player is present at an upward position or a downward position relative to the own player character.

Here, since the horizontally long course is assumed, the example in which the 2P icon 211 is displayed at either the right end or the left end of the screen has been shown. In this regard, in a case where the course has a movable range spreading also in the up-down direction, e.g., a part or the entirety of the course is long also in the vertical direction, the 2P icon 211 may be displayed at a position that reflects a position (hereinafter, x-axis position) of the 2P character 202 on the x axis and that is an upper end or a lower end of the screen, in addition to or instead of an upper end or a left end of the screen.

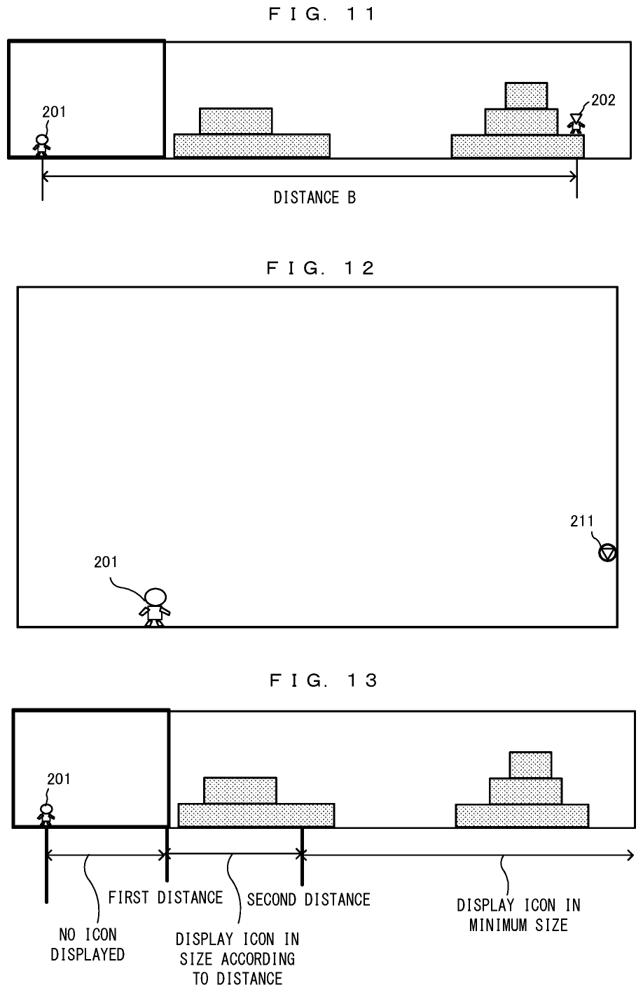

Here, a display example of the 2P icon 211 will be described as a supplementary note. As shown in FIG. 10, the 2P icon 211 is displayed in such a manner that a face image of the 2P character 202 is drawn in a circle frame. This is merely an example, and another image may be adopted as long as the 2P character 202 can be identified. For example, “2P” or letters of a character name or the like may be displayed as the 2P icon 211.

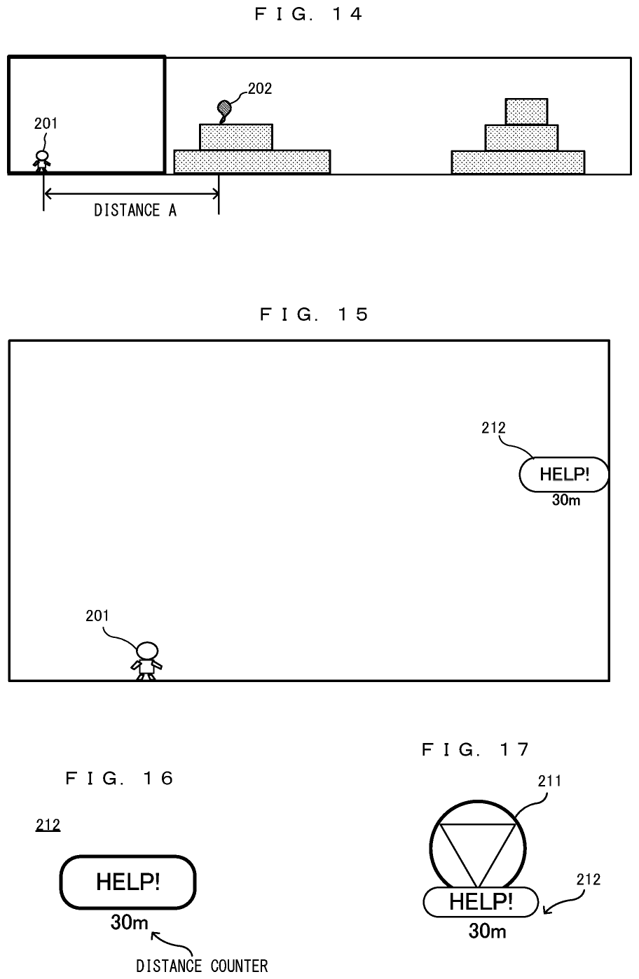

Further, in this exemplary embodiment, the display size of the 2P icon 211 is changed in accordance with the distance between the 1P character 201 and the 2P character 202. Specifically, as the distance between both characters increases, the size of the 2P icon 211 is reduced. Then, when they are away from each other by a certain distance or more, the 2P icon 211 is fixed in the minimum size set in advance. The distance is measured as a straight distance on the x axis in the virtual space. The distance may be measured as a two-dimensional straight distance between the 1P character 201 and the 2P character 202. Thus, it becomes easy for the first player to visually recognize how far the 1P character 201 and the 2P character 202 are away from each other. For example, as shown in FIG. 11, it is assumed that the 1P character 201 and the 2P character 202 are away from each other by a distance B. This distance is longer than the distance A in the state in FIG. 6. In such a case, as shown in FIG. 12, the 2P icon 211 is displayed in a smaller size than in the case of FIG. 7.

FIG. 13 shows a relationship between the size of the 2P icon 211 and the distance from the 1P character 201. In FIG. 13, a first distance is a distance from the position of the 1P character 201 to the right end of the screen, under the assumption that the 1P character 201 can move in the screen. A second distance is a longer distance than the first distance. The second distance is also a predetermined distance set in consideration of the aforementioned “revival assistance function”, as described later. Then, when the 2P character 202 is present within the first distance, the 2P character 202 is directly displayed and therefore the 2P icon 211 is not displayed. When the 2P character 202 is present in a range from the first distance to the second distance, the size of the 2P icon 211 changes in accordance with the straight distance from the 1P character 201 on the x axis. When the 2P character 202 is present at a position farther than the second distance, the 2P icon 211 is displayed with its size fixed at the minimum size. The first distance may be a distance slightly ahead of the right end of the screen.

When the 2P character 202 is present at a position farther than the second distance, the display manner of the 2P icon 211 may be changed. For example, in a case where the 2P character 202 is present in a range from the first distance to the second distance, a face image of the 2P character 202 may be displayed in a circle frame as shown in FIG. 10. On the other hand, in a case where the 2P character 202 is present at a position farther than the second distance, only the face image of the 2P character 202 may be displayed in the minimum size without displaying the circle frame. That is, even in a case where the display manner of the icon is changed in accordance with whether or not the 2P character 202 is within the second distance, the size of the icon when the 2P character 202 is present at a position farther than the second distance is equal to or smaller than the minimum size (i.e., the size of the icon at the second distance) of the icon when the 2P character 202 is present within the second distance.

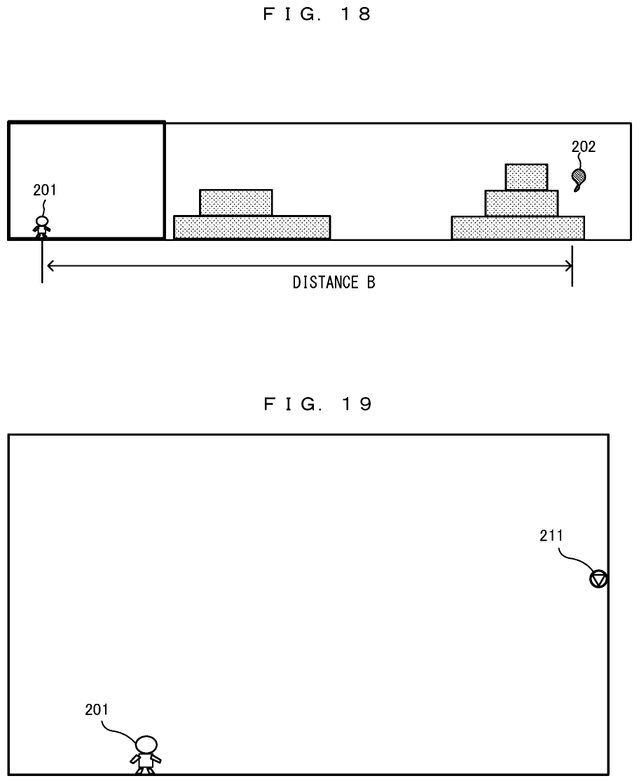

Next, display of the marker in a case where the 2P character 202 is in a revival-waiting state will be described. When the 2P character 202 is changed to a revival-waiting character, the state icon thereof is displayed as the marker. For example, as shown in FIG. 14, in such a positional relationship that the distance between the 1P character 201 and the 2P character 202 is the distance A, it is assumed that the 2P character 202 has changed to a revival-waiting character. In this case, instead of the 2P icon 211, a state icon 212 as shown in FIG. 15 is displayed as a marker, for example. FIG. 16 shows an enlarged view of the state icon 212. As shown in FIG. 16, the state icon 212 is represented as an image including letters ““HELP” and a distance counter indicating an in-game distance to the 2P character 202 as seen from the 1P character 201. Owing to display of the state icon 212 having such a feature, the first player can recognize that the 2P character 202 present outside the screen has become a revival-waiting character and how far the 2P character 202 is away from the own character. In addition, the size of the state icon 212 is changed in accordance with the distance, as in the case of the 2P icon 211. Therefore, it becomes easy to obtain a sense of distance also by the size of the state icon 212. Thus, the first player who has recognized the state icon 212 can be motivated to perform, as it were, a rescue action of causing the 1P character 201 to approach the 2P character 202 using the marker (state icon 212) as a sign, in order to help the 2P character 202.

The state icon 212 may be changed by the second player performing a predetermined operation. For example, while the 2P character 202 is in the revival-waiting state, the state icon 212 of “HELP” may be displayed only when the second player is performing an operation that can temporarily move the 2P character 202 at a high speed (e.g., mashing B button). On the other hand, when such an operation is not being performed, another state icon indicating the revival-waiting state may be displayed. Thus, the first player can estimate whether or not the second player is actively requiring a help, to a certain extent. That is, when the state icon 212 is displayed, it is considered that the second player is moving the 2P character 202 toward the own character in a hurry, and therefore it can be estimated that the second player is requiring a help. As a result, the first player can make determination to perform an operation of actively causing the 1P character 201 to approach the 2P character 202. Even in a case where the second player has come into a revival-waiting state, the 2P icon 211 may continue being displayed unless a predetermined operation is performed.

Regarding the display manner of the distance counter, for example, the distance counter may be displayed as a meter (gauge), instead of a numerical value. As another example, a time counter indicating the remaining time until elapse of the predetermined period may be included in the state icon 212, instead of or in addition to the distance counter. The time counter may be displayed as a numerical value or a meter (gauge). A time counter indicating the elapsed time from when the player character has come into a revival-waiting state, instead of the remaining time, may be displayed, thus indirectly indicating the remaining time. The time or period is not limited to a time concept (such as 1 s, 2 s, . . . ) but may be represented by temporal counting (such as 1, 2, . . . ). In this case, one count may not necessarily correspond to 1 s, and may correspond to 0.8 s or 1.2 s. The number of counts during which the player character can remain in the revival-waiting state or the number of seconds corresponding to one count may be changed in accordance with the game situation.

Regarding the marker when the 2P character 202 is in a revival-waiting state, the example in which the state icon 212 is displayed instead of the 2P icon 211 has been shown in this exemplary embodiment. In this regard, in another exemplary embodiment, for example, an image obtained by adding the state icon 212 to the 2P icon 211 may be displayed as a marker, as shown in FIG. 17. In the example in FIG. 17, the state icon 212 is added near a lower part of the 2P icon 211. In a case where there are a plurality of remote players and a plurality of revival-waiting characters are present, such a marker makes it easy to identify each remote player.

In the above exemplary description of the state icon 212, it has been assumed that the positions of the 1P character 201 and the 2P character 202 are close to each other to a certain extent as in the distance A in FIG. 14. In this regard, for example, it is assumed that the distance between the 1P character 201 and the 2P character 202 is a distance B longer than the distance A, as shown in FIG. 18. The distance B is such a distance that the positions of the 1P character 201 and the 2P character 202 changed to a revival-waiting character cannot be caused to overlap each other within the predetermined period, no matter how the player hurries. That is, the distance B is such a distance that the 1P character 201 cannot make it in time to revive the 2P character 202. If the state icon 212 is displayed also in the case of such a positional relationship, the first player who has recognized the state icon 212 performs a rescue action as described above but ends up failing to revive the 2P character 202 in time, and this might lower amusement of the game on the contrary. Accordingly, in this exemplary embodiment, in a case where the distance between the 1P character 201 and the 2P character 202 is longer than such a distance that the 1P character 201 is estimated to fail to reach the 2P character 202 within the predetermined period, the state icon 212 is not displayed. That is, even when the 2P character 202 has changed to a revival-waiting character, if the distance between both characters is not less than the predetermined distance, the state icon 212 is not displayed and the marker content remains the 2P icon 211, as shown in FIG. 19. With this display control, in a case where the 2P character 202 has changed to a revival-waiting character and there is a possibility of successfully making a rescue action in time, the state icon 212 is displayed to encourage a rescue action. Thus, it is possible to let players feel an advantage obtained owing to online play and encourage players to play online. On the other hand, in a case where a rescue action cannot possibly be made in time, the state icon 212 is restricted from being displayed, whereby it is possible to prevent reduction in amusement of the game.

Here, a distance (hereinafter, referred to as a state icon threshold distance) as a threshold for whether or not to display the state icon 212 is determined in advance on the basis of the predetermined period until a “loss” becomes definite from when the 2P character 202 has become a revival-waiting character. Specifically, the state icon threshold distance is equal to or shorter than an upper limit value of such a distance that presumably allows a character in a normal state to come close to the revival-waiting character by moving during the predetermined period. That is, the threshold distance is based on an assumed range in which it is possible to make it in time to revive the 2P character 202 in a revival-waiting state as seen from the position of the 1P character 201. In this exemplary embodiment, the second distance shown in FIG. 13 is used as the state icon threshold distance. In other words, the state icon threshold distance and the distance serving as the threshold for the 2P icon 211 to be displayed with its size fixed at the minimum size are treated as the same second distance described above. Therefore, in the example in FIG. 13, the 2P icon 211 is basically displayed in a range up to the second distance, and the state icon 212 is displayed when the 2P character 202 has become a revival-waiting character. In addition, in a range up to the second distance, the 2P icon 211 and the state icon 212 are displayed with their sizes changed in accordance with the distance. On the other hand, in a case where the 2P character 202 is present at a position farther than the second distance, the 2P icon 211 in the minimum size is displayed even if the 2P character 202 is changed to a revival-waiting character. In another exemplary embodiment, the second distance and the state icon threshold distance may be set at different values. In this case, for example, the state icon threshold distance may be shorter than the second distance.

As described above, in a case where the 2P character 202 is present at a position farther than the second distance, the circle frame of the 2P icon 211 may not be displayed, and in this case, it becomes easy to let the first player recognize the situation in which state change of the 2P character 202 is not displayed as a marker. That is, the first player who has visually recognized that the circle frame of the 2P icon 211 is not displayed can recognize that the distance is so far that it is impossible to make it in time to revive the 2P character 202, at least at this time.

In this example, the reference position on the 1P character side in measurement for the distance is the position of the 1P character 201, but in another exemplary embodiment, the position of the right end or the left end of the game screen for the first player may be used as a reference to determine the distance to the 2P character 202. That is, with a reference position for the 1P character 201 set, if the distance from the reference position to the 2P character 202 is not less than the state icon threshold distance, the 2P icon 211 may be always used as a marker irrespective of the state of the 2P character 202, without displaying the state icon 212.

In this exemplary embodiment, the example in which the size of the state icon 212 is changed in accordance with the distance to the 2P character 202, has been shown. In this regard, in another exemplary embodiment, the state icon 212 may be displayed with its size fixed at a constant size irrespective of the distance to the 2P character 202.

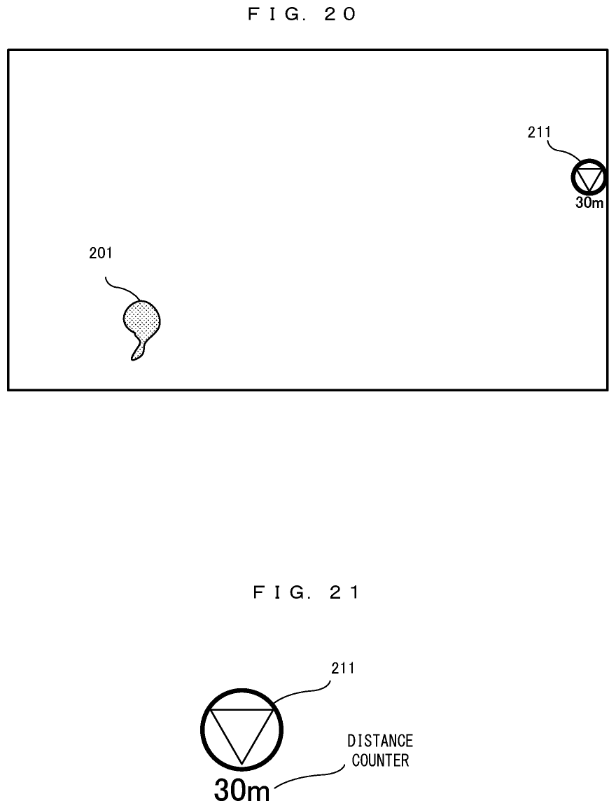

The above description has shown the example in which the 2P character 202 becomes a revival-waiting character. Next, an example of the screen in a case where the 1P character 201 becomes a revival-waiting character will be described. In this case, as a marker for the 2P character 202, a marker shown in FIG. 20 is displayed. FIG. 21 shows an enlarged view of the marker corresponding to the 2P character 202 in this case. In a case where the 1P character 201 has become a revival-waiting character and the 2P character 202 is present within the second distance shown in FIG. 13, an image in which a distance counter indicating the distance to the 2P character 202 is added under the 2P icon 211 is displayed as a marker, as shown in FIG. 21. The first player can recognize a sense of the distance to the 2P character 202, using the distance counter as well in combination. In this regard, in another exemplary embodiment, only the distance counter may be displayed as a marker instead of the 2P icon 211. In a case where the 2P character 202 is present farther than the second distance, the distance counter is not displayed. This is because it is impossible to make it in time for revival, as described above.

Here, in this exemplary embodiment, the example in which the state icon 212 is displayed when the 2P character 202 has come into a revival-waiting state, has been shown. In this regard, a content to be displayed as the state icon 212 may be made different in accordance with another state different from the revival-waiting state. For example, each player may be allowed to perform emotion display through a predetermined operation. The emotion display refers to display of an image indicating the feeling or emotion of the player. For example, an icon of a smiley face or an icon of letters such as “Hello” can be used as emotion display. When each player performs an emotion display operation, an emotion image is displayed near the own player character. Then, for example, when the second player for the 2P character 202 present outside the screen performs an emotion display operation, the content of the marker may be changed to an emotion display image to indicate that the 2P character 202 is in an “emotion display state”, during a predetermined period.

As another example of the state of the player character, when each player character acquires a predetermined item placed in the course, the state of the player character may be changed into a special state. In this case, an image indicating that the player character is in the special state may be displayed as the state icon 212. Thus, for example, the first player can recognize that the 2P character 202 has changed into a special state. In addition, as described above, control is performed such that the state icon 212 is not displayed in a case where the distance to the 2P character 202 is not less than a certain distance. In other words, the fact that the state icon 212 indicating the special state is displayed means that there is a high possibility that an item that enables change into the special state is placed near the present position of the 1P character 201. Therefore, the first player who has recognized the state icon 212 indicating the special state can search for the item that enables change into the special state, in an area near the present position, with reference to the marker for the 2P character 202. In addition, for example, in a case where the special state of the player character is such a state that the player character can reach a specific area in the virtual space which cannot be reached by a player character in a normal state, the first player can recognize that the state icon 212 is displayed in such a manner that indicates that the 2P character 202 is present at a certain position (direction) because the 2P character 202 is in the special state, and can infer that the 1P character 201 also needs to change into the special state in order to reach the same position. Regarding the item that enables change into the special state, information about the item acquisition state may be shared among online players. For example, one such item may be placed in the course on each game apparatus 3, and when one of the players has acquired the item, the item may be deleted in the courses for the other players. That is, the game may be configured such that only one such item may be placed in the entire course room and this item can be acquired only by the first-come player. Also in this case, the first player who has seen the state icon 212 indicating the special state can recognize that the item that enables change into the special state is present around there, and thus can utilize the state icon 212 as reference information for acquiring the item in next play, though the first player has failed to acquire the item in play at this time.

In a case where the state of the 2P character 202 has become a specific state, the marker may be changed to a specific state icon indicating that the 2P character 202 is in the specific state, irrespective of the distance from the 1P character 201. An example of the specific state is a state in which the 2P character 202 disappears from the course. For example, it is assumed that the 2P character 202 has reached the goal and cleared the course earlier than the 1P character 201. The second player (2P character 202) that has cleared the course is to exit the course room. In this case, for example, a specific state icon such as an image of a flag indicating that the second player has reached the goal (exited the course room) may be displayed irrespective of the distance to the 2P character 202. At this time, the specific state icon may be displayed in a constant size irrespective of the distance to the 2P character 202. In addition, for example, also in a case where the remaining lives of the 2P character 202 have run out so that the second player has ended up game over and has exited the course room, the content of the marker may be changed. For example, a cross-mark image or the like may be displayed in a circle frame irrespective of the distance. In a case where another player has reached the goal or ended up game over and thus has exited the course room (disappeared), it is considered that it is difficult to recognize that the other player has disappeared if the marker is merely deleted. Accordingly, clearly indicating the fact by the marker as described above makes it easy to recognize that the other player has disappeared. In addition, also in a case where the 2P character 202 has lost a life while having the remaining lives, i.e., in a case where the 2P character 202 temporarily disappears from the course to restart play, the specific state icon may be displayed irrespective of the distance to the 2P character 202. As another example, the specific state may be a state in which the 2P character 202 has joined in the course (has started play in the course).

As described above, in a case where the state of the 2P character 202 is a specific state, the specific state icon is displayed irrespective of the distance, and thus it is possible to selectively use marker display in accordance with importance of information to be given as a marker to the first player. For example, information indicating a specific state such as a state in which another player character has reached a goal or has ended up game over as described above is comparatively important for the first player, and therefore can be always displayed as a marker irrespective of the distance. On the other hand, regarding information such as a revival-waiting state whose importance varies depending on the distance from the 1P character 201, whether or not to display the information is switched in accordance with the distance, whereby comfortable game play is achieved.

The specific state icon indicating that a character has come into a specific state may be deleted after being displayed for a certain period. This is because the first player is sufficiently notified about the state of the 2P character 202.

Next, the details of the game processing according to the first exemplary embodiment will be described. Here, processing on the game apparatus 3 will be mainly described. In the game server 1, processing for matching players and processing for managing course rooms can be performed, but such processing is not directly relevant to display control for the above marker and therefore the description of processing in the game server 1 is omitted.

### [Data Used in Game Apparatus 3]

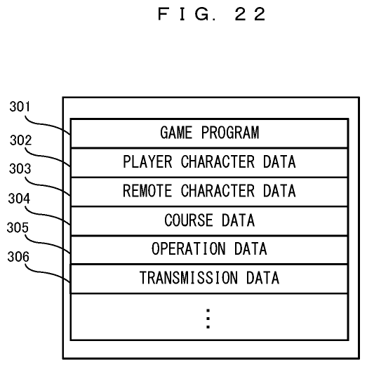

First, data used in the game apparatus 3 will be described. FIG. 22 is a memory map showing an example of various data to be stored in the DRAM included in the storage unit 32 of the game apparatus 3. As the various data, for example, some data are read as necessary from game data stored in a dedicated memory card or the like and are stored in the DRAM. In addition, temporary data needed for the game processing are generated in the DRAM. The DRAM included in the storage unit 32 of the game apparatus 3 stores at least a game program 301, player character data 302, remote character data 303, course data 304, operation data 305, and transmission data 306.

The game program 301 is a program for executing the game processing according to this exemplary embodiment on the game apparatus 3.

The player character data 302 is data about the 1P character 201 which is an operation target of the first player. The player character data 302 includes data indicating the position of the 1P character 201 in the course data, data indicating the state of the 1P character 201 such as whether or not the 1P character 201 has changed into a revival-waiting character, and the like.

The remote character data 303 is data about the 2P character 202 received from another game apparatus. For example, the remote character data 303 includes information indicating the position of the 2P character 202 in the course and information indicating the state of the 2P character 202. In this exemplary embodiment, the example in which two players are in the course room has been shown, but for example, in a case where four players are in the course room, the remote character data 303 for three players can be stored.

The course data 304 includes data for creating a course as a target to be played. Specifically, the course data 304 includes data indicating position information of a start point and a goal point, the outer appearances of various objects to be placed, placement positions, action patterns, and the like.

The operation data 305 is data obtained from the controller 4 operated by the player. That is, the operation data 305 is data indicating the content of an operation performed by the player.

The transmission data 306 is data to be used for transmitting, to another game apparatus, information indicating the present position of the 1P character 201 in the course and the present state (such as a normal state or a revival-waiting state) thereof.

### [Details of Processing Executed by Processor 31 of Game Apparatus 3]

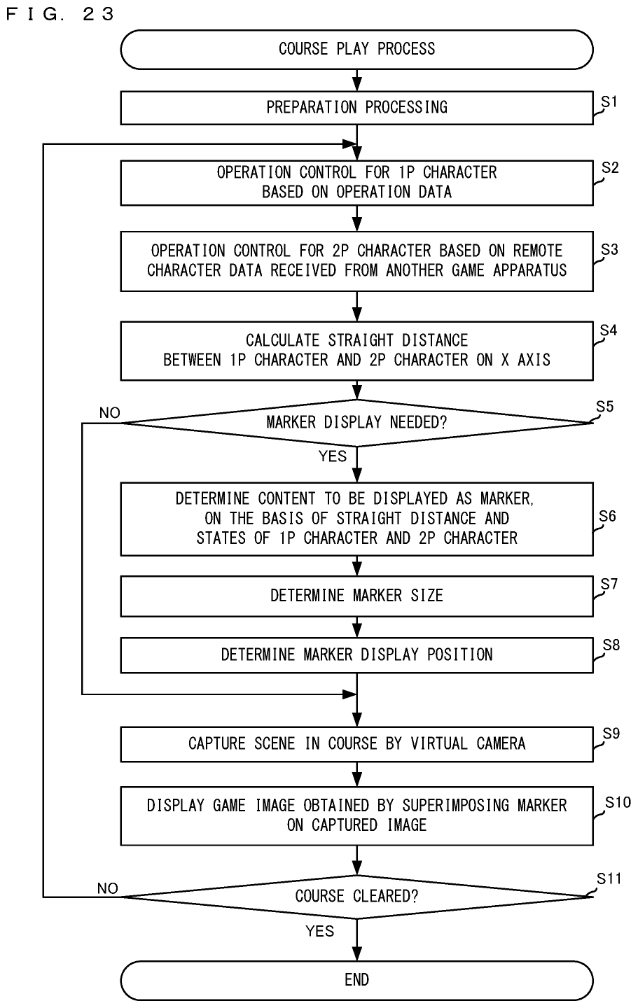

Next, the details of a course play process executed by the processor 31 of the game apparatus 3 will be described. FIG. 23 is a flowchart showing the details of the course play process. In this exemplary embodiment, one or more processors read and execute the programs stored in one or more memories, thus implementing the flowchart shown below. Here, processing relevant to display control for the marker will mainly be described, and the detailed description of other game processing is omitted. The flowchart shown below is merely an example of a processing procedure. Therefore, the processing order of steps may be changed as long as the same result is obtained. In addition, the values of variables and thresholds used in determination steps are also merely examples and other values may be used as necessary.

When an instruction to play for a predetermined course is performed on the game apparatus 3, the course play process is started. When the course play process is started, first, in step S1, the processor 31 executes preparation processing. In the preparation processing, the following processing is performed. First, a request for matching processing is transmitted to the game server 1, and as a result, a first player and a second player are matched. Further, the matching result is received from the game server 1, and on the basis thereof, processing for establishing a communication session for the game apparatuses 3 of the first player and the second player is executed. Next, the processor 31 reads the course data 304 for the designated course from a dedicated memory card or the like, and stores the course data 304 in the DRAM. Then, on the basis of the course data 304, processing of creating the course to be played at this time is performed. Further, processing of placing various objects such as the 1P character 201 and enemy characters on the created course is performed. Then, the course is captured by a virtual camera, a game screen just after the game is started is generated, and the game screen is displayed on the display unit 5.

Next, in step S2, the processor 31 performs operation control for the 1P character 201 on the basis of the operation data 305. Along with this, the processor 31 transmits the transmission data 306 including information indicating the present position and the present state of the 1P character 201, to the other game apparatus 3.

Next, in step S3, the processor 31 performs operation control for the 2P character 202. Specifically, the processor 31 moves the 2P character 202 on the basis of the remote character data 303 received from the other game apparatus 3.

Next, in step S4, the processor 31 calculates the straight distance between the 1P character 201 and the 2P character 202 on the x axis of the coordinate system in the course.

Next, in step S5, the processor 31 determines whether or not a marker as described above needs to be displayed, on the basis of the calculated distance. Specifically, if the distance between the 1P character 201 and the 2P character 202 is such a distance that they are displayed within one screen (less than the first distance), it is determined that marker display is not needed. On the other hand, if the distance is such a distance that the 2P character 202 is located outside the screen with the 1P character 201 as a reference (not less than the first distance), it is determined that marker display is needed. The above processing is merely an example, and as another example, whether or not marker display is needed may be determined on the basis of whether or not the 2P character 202 is present in a capturing range of the virtual camera.

As a result of the above determination, if it is determined that marker display is not needed (NO in step S5), the process proceeds to step S9 described later. On the other hand, if it is determined that marker display is needed (YES in step S5), in step S6, the processor 31 determines a content to be displayed as the marker, on the basis of the calculated straight distance and the states of the 1P character 201 and the 2P character 202. For example, if the straight distance is less than the second distance shown in FIG. 13 and the 1P character 201 and the 2P character 202 are in normal states, it is determined that the 2P icon 211 is to be displayed as the content of the marker. If the straight distance is less than the second distance, the 1P character 201 is in a normal state, and the 2P character 202 is in a revival-waiting state or an emotion display state, it is determined that the state icon 212 is to be displayed as the content of the marker. If, for example, the 1P character 201 is in a revival-waiting state, the 2P character 202 is in a normal state, and the distance to the 2P character 202 is less than the second distance, an image in which the distance counter is added to the 2P icon 211 as shown in FIG. 21 is determined as the content of the marker. On the other hand, if the straight distance is not less than the second distance, it is determined that the 2P icon 211 is to be displayed irrespective of the state of the 2P character 202. If, for example, the 2P character 202 has reached the goal, the specific state icon indicating that the 2P character 202 has reached the goal is determined as the display content of the marker, irrespective of whether or not the straight distance is not less than the second distance. The display manner of the specific state icon may be the same irrespective of the distance from the 1P character 201, or may differ in accordance with the distance. For example, the specific state icon may be displayed with a frame when the distance is less than a certain distance, and may be displayed without a frame when the distance is not less than the certain distance.

Next, in step S7, the processor 31 determines the display size of the marker on the basis of the states of the 1P character 201 and the 2P character 202 and the calculated straight distance. Specifically, if the straight distance is less than the second distance, the processor 31 determines the display size of the 2P icon 211 or the state icon 212 in accordance with the straight distance. If the straight distance is greater than the second distance, the processor 31 determines the display size of the 2P icon 211 to be the minimum size. In a case of displaying the specific state icon as a marker, the specific state icon may be displayed in a constant size irrespective of the distance from the 1P character 201.

Next, in step S8, the processor 31 determines the display position of the marker on the basis of the positional relationship between the 1P character 201 and the 2P character 202. First, the processor 31 determines whether to display the marker at the right end or the left end of the game screen of the first player. For example, it is assumed that the start point is at the left end of the course and the goal point is at the right end of the course. In this case, if the 2P character 202 located outside the screen is present at a position closer to the start point than the 1P character 201 is, the processor 31 determines the left end of the game screen as the display position of the marker. On the other hand, if the 2P character 202 is present at a position closer to the goal point, the processor 31 determines the right end of the game screen as the display position of the marker. Next, the processor 31 determines the display position of the marker on the y axis of the screen, on the basis of the position of the 2P character 202 on the y axis of the course coordinate system. Thus, the position that is at the right end or the left end of the screen and according to the y-axis position of the 2P character 202 is determined as the display position of the marker. Depending on the structure of the course, a position that is at the upper end or the lower end of the screen and according to the x-axis position of the 2P character 202 may be determined as the display position of the marker.

Next, in step S9, the processor 31 moves the virtual camera to a predetermined position determined on the basis of the position of the 1P character 201 and captures the course from that position. This position is such a position that the 1P character 201 is seen at approximately the center in the x-axis direction on the game screen, for example.

Next, in step S10, the processor 31 superimposes the image of the marker at the determined display position on the captured image, to generate a game image. Then, the processor 31 displays the generated game image on the display unit 5.

Next, in step S11, the processor 31 determines whether or not the 1P character 201 has reached the goal point and cleared the course. If the 1P character 201 has not reached the goal point yet (NO in step S11), the process returns to step S2 so as to be repeated. If the 1P character 201 has reached the goal point (YES in step S11), it is determined that the course has been cleared, and the processor 31 displays a predetermined clearing presentation or the like and ends the course play process. Along with this, the communication session with the other game apparatus 3 is shut off and the course room is exited.

As described above, in the first exemplary embodiment, in a case where the 2P character 202 located outside the screen is closer than a predetermined distance, the first player can find that, for example, the 2P character 202 has come into a revival-waiting state, and thus the first player can advance the game in accordance with the position and the state of the 2P character 202. On the other hand, in a case where the 2P character 202 is farther than the predetermined distance, the first player cannot find that, for example, the 2P character 202 is in a revival-waiting state. Therefore, while the first player recognizes that the 2P character 202 is present in the same course and recognizes the position thereof, the first player is not notified of state change to a revival-waiting state or the like more than necessary and thus amusement of the game is prevented from being lowered by the first player being notified of such information more than necessary.

### Second Exemplary Embodiment

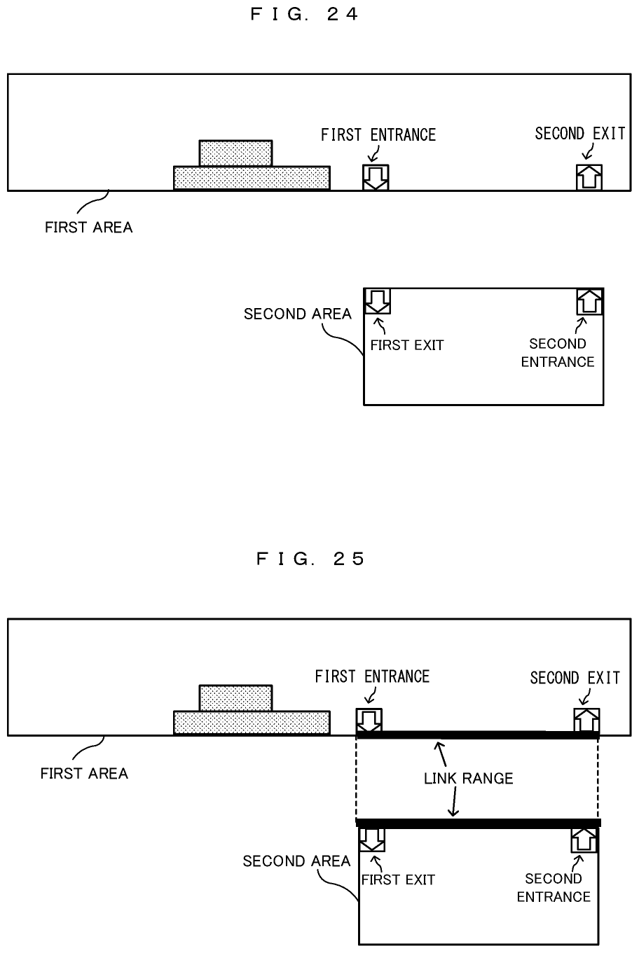

Next, the second exemplary embodiment will be described. The above first exemplary embodiment has shown the example in which the structure of the course is made such that the terrain from the start point to the goal point is formed in the same virtual space. That is, the entire course in the first exemplary embodiment is formed as one area. In the second exemplary embodiment, for example, such a course structure that two different areas, i.e., a first area and a second area, are included in one course as shown in FIG. 24, is assumed. The two areas are formed as separate virtual spaces. That is, these areas are not connected as a continuous ground. Then, for example, by moving a player character to a first entrance in the first area in FIG. 24 and performing a predetermined operation, the player character can be moved to a first exit in the second area. In addition, by moving the player character to a second entrance in the second area and performing a predetermined operation, the player character can be moved to a second exit in the first area. At this time, the player character may come out from the exit in the same direction as when going into the entrance. For example, when the player character has gone into the entrance so as to move downward, the player character may come out from the exit so as to move downward. In FIG. 24, a case where the in-game distance from the first entrance to the second exit in the first area coincides with the in-game distance from the first exit to the second entrance in the second area, is shown, but both distances may not necessarily coincide with each other.

Regarding the first area and the second area, in terms of game data, a file for the first area and a file for the second area are created as separate files. Then, every time movement to another area occurs in each game apparatus 3, the file for the movement-destination area is loaded again into the DRAM.

The second area may be like a “hidden route”, for example. That is, it is possible to clear the course without going to the second area, but an item that gives an advantage to the player may be placed in the second area or the second area may be used as a shortcut to the goal point.

In such a course configuration that two or more areas are present in one course as described above, for example, a situation in which the 1P character 201 is present in the second area and the 2P character 202 is present in the first area, can occur. In such a situation, since the 2P character 202 is not present in the same area (virtual space) as the 1P character 201, the straight distance on the x axis as described above cannot be calculated and the marker for the player character in another area cannot be displayed. In this regard, in the second exemplary embodiment, also in a case where another player character is present in another area, the marker as described above is displayed so that it appears as if both areas are connected to each other as a continuous ground. Specifically, a marker for a player character present in another area is displayed by the following method.

First, for the first area and the second area, a relative position relationship is defined. Specifically, as shown in FIG. 25, a “link range” having the same length as the horizontal width of the upper side of the second area is defined. The link range is invisible. Then, the link range is located at a predetermined position in the first area. Here, the link range is located on the lower side of the first area such that the first entrance and the second exit are at both ends of the link range, as an example. In this example, a position on the x axis in the link range is defined so as to be the same between the first area and the second area. Thus, a relative relationship of positions in the x-axis direction between a part of the lower side of the first area and the upper side of the second area is defined.

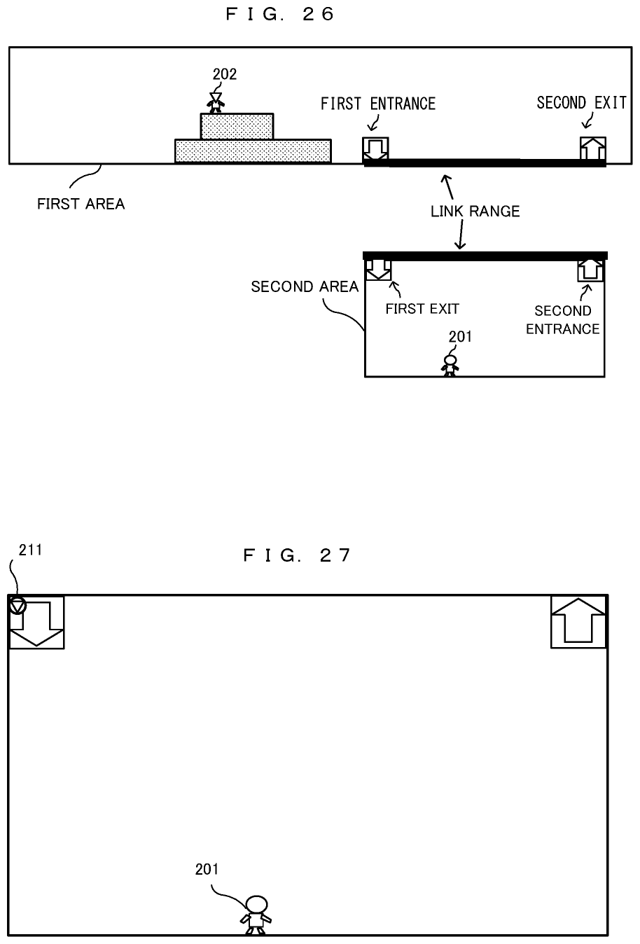

Under the relationship of relative positions as described above, for example, a case where the 1P character 201 is present in the second area and the 2P character 202 is present in the first area with a positional relationship as shown in FIG. 26, is assumed. In the case of FIG. 26, the position of the 2P character 202 on the x axis is not in the link range. In this case, the game screen of the first player is displayed as shown in FIG. 27. In FIG. 27, a marker is displayed at the upper left corner of the screen. That is, in a case where the 2P character 202 is present outside the link range, the right end or the left end of the link range is used as the display position of the marker in accordance with whether the 2P character 202 is present on the right side or the left side of the link range.

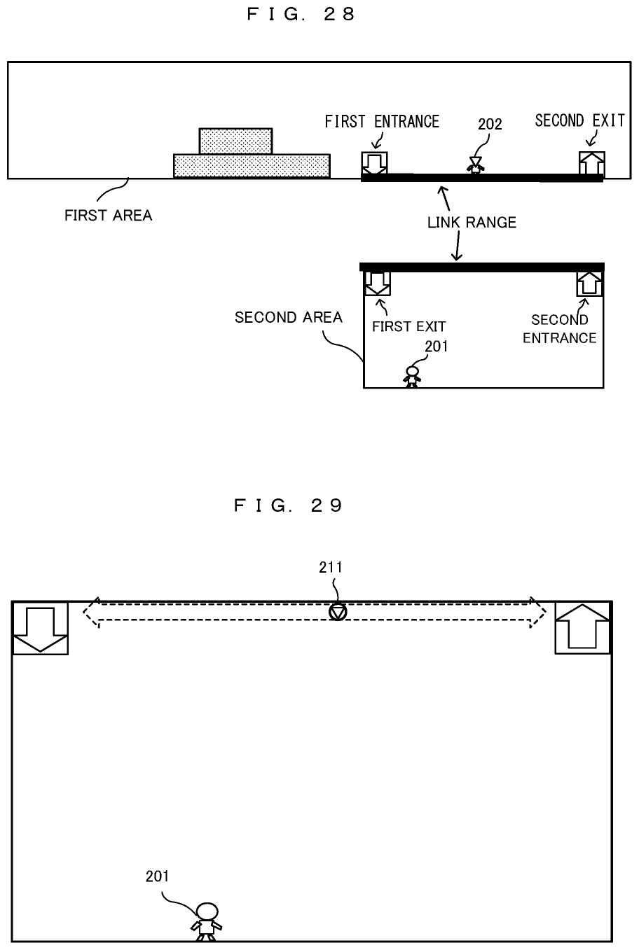

Next, it is assumed that, from the state in FIG. 26, the 2P character 202 is moved so that the x-axis position thereof comes into the link range as shown in FIG. 28. In this case, on the game screen of the first player, the marker (2P icon 211) is displayed such that the x-axis position of the 2P character 202 in the link range is reflected, as shown in FIG. 29. That is, while the 2P character 202 is present in the link range, the display position of the marker can move leftward or rightward in real time in accordance with movement of the 2P character 202.

Here, as the marker for the 2P character 202 present in the other area, the 2P icon 211 in the minimum size is always displayed. That is, the 2P character 202 present in the other area is always treated as being present at a position farther than the second distance shown in FIG. 13. Therefore, even if the 2P character 202 present in the other area has come into a revival-waiting state, this is not reflected in display of the marker. Even if this were reflected, it is difficult for the 1P character 201 to perform a rescue action because the areas are different.

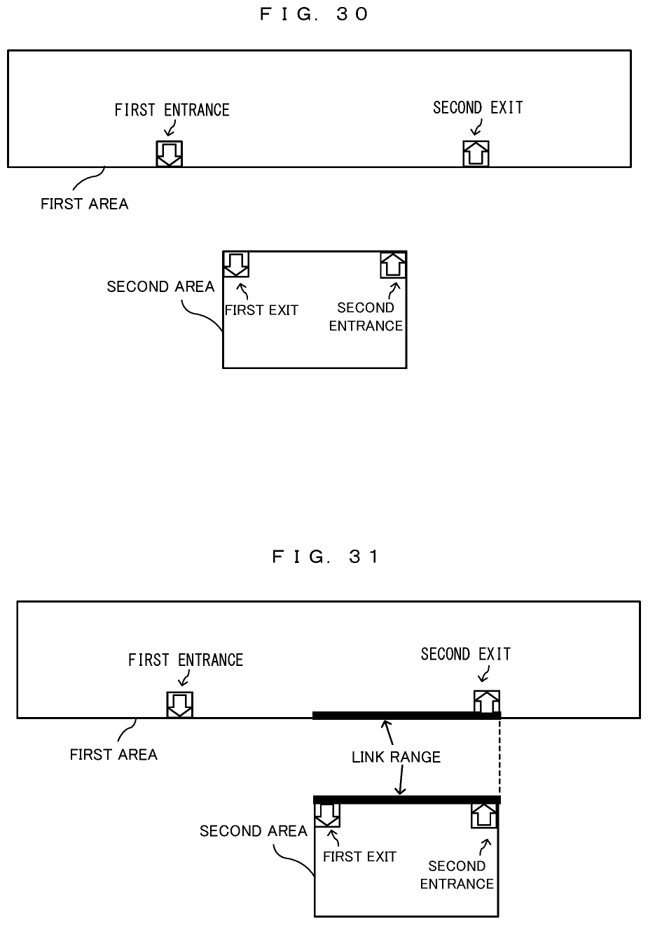

FIG. 30 and FIG. 31 show a setting example of a link range in a case where the in-game distance from the first entrance to the second exit in the first area does not coincide with the in-game distance from the first exit to the second entrance in the second area. As shown in FIG. 30, it is assumed that the horizontal width of the second area is shorter than the in-game distance from the first entrance to the second exit in the first area. As described above, the link range may be set as appropriate. In this case, for example, where the first area and the second area are on the same xy plane, the link range may be set such that only either the entrance-side ends or the exit-side ends are aligned at the same x-axis position. The link range may have any length. For example, the entire width of the area having the shorter horizontal width may be used as the length of the link range. For example, as shown in FIG. 31, the link range having the same horizontal width as the second area may be set in the first area such that the exit-side ends are aligned. Also in this case, when the x-axis position of the 2P character 202 is in the link range in the first area, as shown in FIG. 29, the marker is displayed on the screen of the first player such that the marker can move leftward or rightward along the upper side of the screen in accordance with leftward/rightward movement of the 2P character 202. When the x-axis position of the 2P character 202 is outside the link range, the display position of the marker is fixed at either of the upper left and right corners.

Here, in the example shown in FIG. 31, it is assumed that the 1P character 201 and the 2P character 202 are both present at the first entrance, and the first entrance, the 1P character 201, and the 2P character 202 are displayed at the center of the game screen of the first player. At this time, when the 2P character 202 goes into the first entrance, the 2P character 202 comes out from the first exit, and then, on the game screen of the first player, the marker for the 2P character 202 is displayed at the right corner instead of the center on the lower side of the screen. Therefore, it appears to the first player that the 2P character 202 moves rightward at a high speed. In order to prevent high-speed movement of the marker position upon movement between areas as described above, the length (horizontal width) of the set link range may be made different between the first area and the second area in accordance with the horizontal widths of both areas. However, in this case, for example, when the marker is moved in accordance with movement of the 2P character 202 in the link range, the movement speed of the marker is higher or lower than the actual movement speed of the 2P character 202.

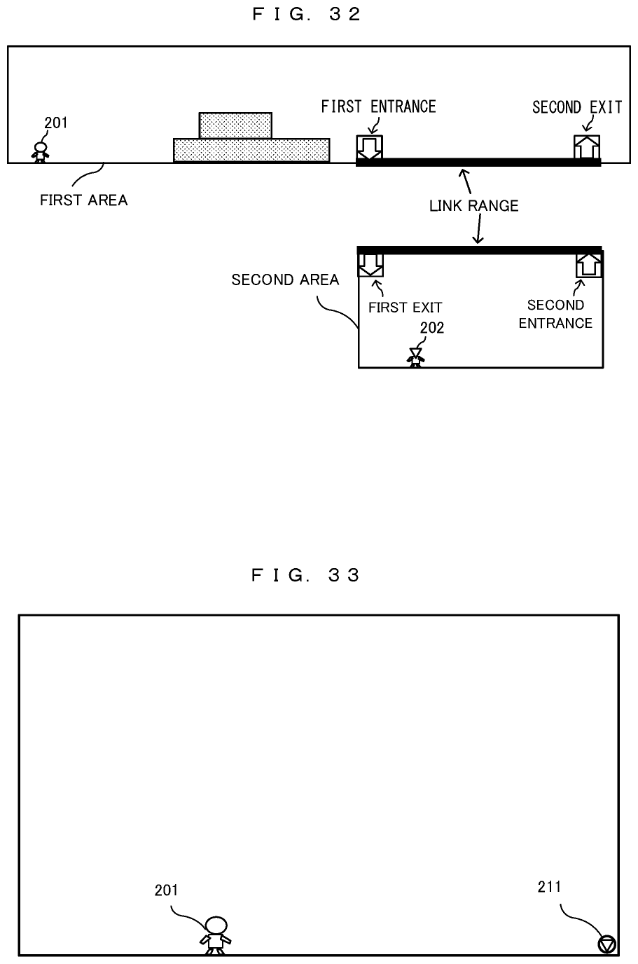

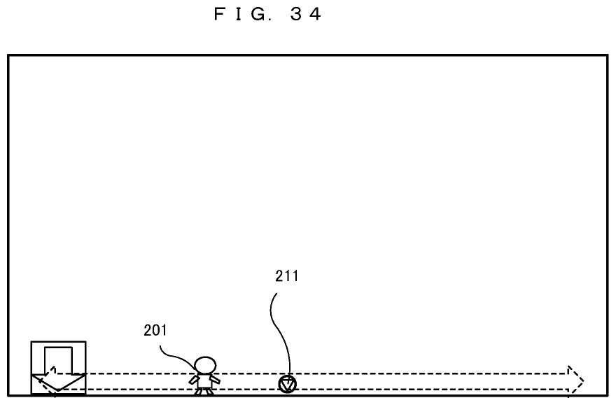

Next, FIG. 32 to FIG. 34 show an example in which the 1P character 201 is present in the first area and the 2P character 202 is present in the second area, in contrast to the above case. First, it is assumed that the 1P character 201 and the 2P character 202 are in such a positional relationship as shown in FIG. 32. In this case, on the game screen of the first player, the 2P icon 211 in the minimum size is fixedly displayed at the lower right corner of the screen, as shown in FIG. 33. Then, from the state shown in FIG. 32, if the x-axis position of the 1P character 201 has moved to a position in the link range, on the game screen of the first player, the 2P icon 211 in the minimum size can move leftward or rightward along the lower side of the screen as shown in FIG. 34, for example.

In the above examples, the case where relative positions of a lower-side part of the first area and an upper-side part of the second area are associated with each other, has been shown. However, conversely, relative positions of an upper-side part of the first area and a lower-side part of the second area may be associated with each other. In this case, it is possible to make it appear as if the second area is present above the first area.

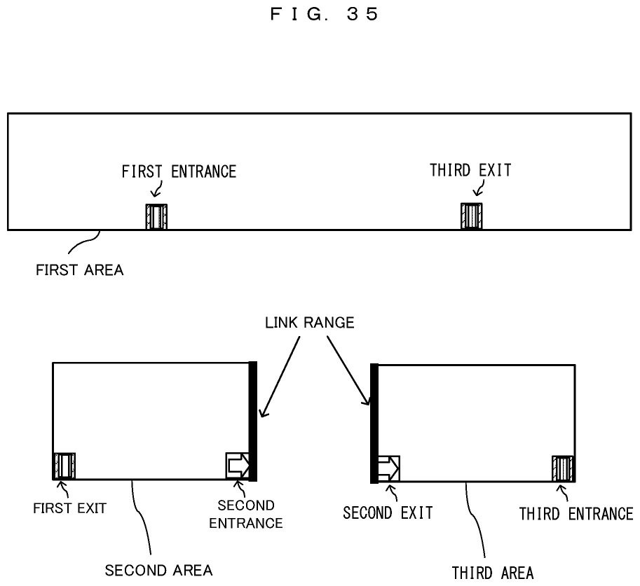

In the above examples, the case where relative positions of horizontal side parts of the areas are associated with each other, has been shown. In another exemplary embodiment, for example, vertical side parts of the areas may be associated with each other. For example, a course structure as shown in FIG. 35 is assumed. FIG. 35 shows an example of a course including three areas, i.e., first to third areas. In FIG. 35, the course is configured so as to allow a player character to move from the first entrance in the first area to the first exit in the second area, move from the second entrance in the second area to the second exit in the third area, and move from the third entrance in the third area to the third exit in the first area. Then, under this course structure, the right side of the second area and the left side of the third area may be defined as the link range. Thus, for example, in a case where the 1P character 201 is present in the second area and the 2P character 202 is present in the third area, the marker in the minimum size is displayed at the right end of the screen of the first player. In addition, the marker moves in the up-down direction in accordance with movement in the y-axis direction of the 2P character in the link range.

In the example shown in FIG. 35, for example, if it is not particularly necessary to let a player be aware of positional relationships between the first area and the second area and between the first area and the third area, link ranges need not be defined between these areas. For example, in a case of providing such a presentation that the 1P character 201 goes into a deep side of the screen from the first entrance and then comes out to a near side of the screen from the first exit, it is not necessary to let a player be aware of positional relationships in up-down and left-right directions between the areas. At this time, for example, in a case where the 1P character 201 is present in the first area and the 2P character 202 is present in the second area or the third area, the marker for the 2P character 202 is not displayed on the screen of the first player. On the other hand, for example, in FIG. 35, if it is necessary to let a player be aware of a positional relationship between the second area and the third area, the link range may be defined as described above. In this way, whether or not to define the link range may be selected in accordance with whether or not to let a player be aware of a positional relationship between different areas. In the example shown in FIG. 35, the start point and the goal point may be both present in the first area. In this case, as shown in FIG. 35, a link range may be defined between areas that both do not have the start point and the goal point. At least one area may be imparted with no link range with the area that has both of the start point and the goal point.

As described above, in the second exemplary embodiment, a relative relationship of positions is defined for different areas regarded as included in the same course. Then, on the basis of the definition, the display position of the marker for a player character present in another area is determined. Thus, the relationship of relative positions between the different areas can be shown to the player via the marker as described above. As a result, it is possible to make it appear as if a plurality of areas that are not directly connected to each other are connected to each other. For example, if the first player notices that the 2P icon 211 is moving leftward or rightward along the lower side of the screen in the link range, the first player can notice that there is a gimmick for moving to another area therearound. In a case where a plurality of areas are present in the same course as shown in the second exemplary embodiment, the start point and the goal point may be set in the same area or may be set in different areas. Therefore, it is not always necessary to return to the area where the start point is present, after moving to another area from the area where the start point is present.

### Modifications

In the above description, online multiplay in a state in which a plurality of game apparatuses 3 are connected via the Internet has been assumed. In another exemplary embodiment, the above processing may be applied in a local multiplay condition in which a plurality of players play a game using one game apparatus 3. For example, game images for the respective players may be displayed on one display unit in a so-called split screen manner and marker display control may be performed as described above.

In the above second exemplary embodiment, marker display in the case where a plurality of areas are included in one course has been described. In this regard, depending on the course, control may be performed so that the marker is not displayed for a player character present in another area. That is, in accordance with the course configuration, control may be performed so that the marker for a player character present in another area is displayed or intentionally not displayed. Thus, it is possible to provide a course having increased amusement using a feature that the present position of another player character cannot be estimated.

In the above second exemplary embodiment, the case where a relative relationship of positions between different areas is defined in a form of link range, has been shown. However, without limitation to a form of “link range”, any relationship may be used. For example, using a predetermined relationship, an x-axis position in one area may be converted to an x-axis position in another area. For example, x coordinates may be adjusted between areas in advance, whereby the value of an x coordinate in one area may be directly associated with the value of an x coordinate in another area. For example, with the x-axis position of the 2P character 202 in one area associated with an x-axis position in another area, the display position of the 2P icon 211 may be determined using the associated position and the position of the 1P character 201.

In the above exemplary embodiments, the case where the display position of the 2P icon 211 on the y axis and the x axis on the game screen of the first player reflects the position of the 2P character 202 on the y axis and the x axis in the virtual space, has been shown. However, the display position may be determined in a different manner. For example, the 2P icon 211 may be displayed at a position according to an intersection of an edge of the game screen of the first player and a line connecting the 1P character 201 and the 2P character 202 present outside the game screen of the first player, e.g., may be displayed near the intersection.

In the above exemplary embodiments, the case where the 2P icon 211 is displayed at an upper, lower, left, or right end of the game screen of the first player, has been shown. However, the 2P icon 211 may be displayed at a position other than the above ones. For example, a rectangular or circular area in which the 2P icon 211 can move may be displayed at a corner of the game screen of the first player, and the 2P icon 211 may be displayed at a position in the area based on the positions of the 1P character 201 and the 2P character 202.

In the above exemplary embodiments, the game that advances on a 2D screen has been shown as an example. However, without limitation thereto, in another exemplary embodiment, the above processing can be applied to a game in which a game screen is displayed as a 3D screen based on a first-person viewpoint, a third-person viewpoint, or the like and online multiplay can be performed as described above.

In the above exemplary embodiments, the “revival assistance” has been shown as an example of a cooperative-play feature. This “revival assistance” is to exert such an in-game effect that a player character in a revival-waiting state is revived from the revival-waiting state when becoming close to another player character within a predetermined period. In this regard, in another exemplary embodiment, without limitation to such “revival assistance” as described above, another in-game effect may be exerted when a player character becomes close to another player character within a predetermined period. For example, it is assumed that the 2P character 202 acquires a predetermined item and thus changes into a state in which upgrading is possible. Then, when the 2P character 202 becomes close to the 1P character 201 within a predetermined period, an effect of upgrading the 2P character 202 may be exerted. Also in this case, through marker display control as described above, a motivation for each player to come close to another player is increased and a sense of distance to another player character is recognized, whereby amusement of the game can be improved. Alternatively, when the 2P character 202 acquires a predetermined item, the 2P character 202 may change into a state in which downgrading is possible. Then, when the 2P character 202 becomes close to the 1P character 201 within a predetermined period, an effect of downgrading the 2P character 202 may be exerted. In this way, also in a case of exerting a disadvantageous in-game effect on the 2P character 202, each player is motivated to operate the 2P character 202 so as to run away from the 1P character 201 or operate the 1P character 201 so as to catch up with the 2P character 202 for the purpose of harming, whereby amusement of the game can be improved.

In the above exemplary embodiments, it has been assumed that the predetermined period within which a player character can revive from a “revival-waiting state” is a fixed period. In this regard, in another exemplary embodiment, the predetermined period may be variable. For example, as the number of times a player character has changed into a “revival-waiting state” increases, the predetermined period may be shortened. In this case, the state icon threshold distance may be equal to or shorter than a distance that a player can travel within the predetermined period that has become shortest. That is, the state icon threshold distance may be such a distance that a player character can reach the 2P character 202 in a revival-waiting state within the variable predetermined period no matter what length the variable predetermined period has. The state icon threshold distance may be changed in accordance with change in the predetermined period.

In the above exemplary embodiment, the case where the sequential processing in the game processing is executed by a single game apparatus 3 has been described. In another exemplary embodiment, the sequential processing may be executed in an information processing system including a plurality of information processing apparatuses. For example, in an information processing system including a terminal-side apparatus and a server-side apparatus that can communicate with the terminal-side apparatus via a network, a part of the sequential processing may be executed by the server-side apparatus. In an information processing system including a terminal-side apparatus and a server-side apparatus that can communicate with the terminal-side apparatus via a network, a major part of the sequential processing may be executed by the server-side apparatus and a part of the sequential processing may be executed by the terminal-side apparatus. In the information processing system, a server-side system may include a plurality of information processing apparatuses and processing to be executed on the server side may be executed by the plurality of information processing apparatuses in a shared manner. A configuration of so-called cloud gaming may be adopted. For example, the game apparatus 3 may transmit operation data indicating a player's operation to a predetermined server, various game processing may be executed on the server, and the execution result may be distributed as a video and a sound by streaming to the game apparatus 3.

While the present disclosure has been specifically described herein, it is to be understood that the above description is, in all aspects, merely an illustrative example, and is not intended to limit the scope thereof. It is to be understood that various modifications and variations can be made without deviating from the scope of the present disclosure.

What is claimed is:

1. One or more computer-readable non-transitory storage media having stored therein a game program that causes one or more processors of one or more information processing apparatuses to:
move a first player object in a virtual space in accordance with an operation input by a player;
control a virtual camera for generating a game image, in association with a position of the first player object;
when a second player object operated by another player is present at a position outside a range of the game image in the virtual space, generate a 2P icon indicating the second player object so that the 2P icon is displayed at a position that is in the game image and according to the position of the second player object; and
in generating the 2P icon, when the second player object is in a first state,
if a distance to the position of the second player object from a reference position for the first player object is less than a predetermined distance, generate, instead of the 2P icon or in addition to the 2P icon, a state icon indicating the first state so that the state icon is displayed at a position that is in the game image and according to the position of the second player object, and
if the distance to the position of the second player object is not less than the predetermined distance, generate the 2P icon so that the 2P icon is displayed in the game image without generating the state icon.

2. The one or more computer-readable non-transitory storage media having stored the game program according to claim 1, wherein
the first state continues for a predetermined period and is such a state that a predetermined in-game effect will be exerted by the first player object and the second player object coming close to each other while the first state is continuing.

3. The one or more computer-readable non-transitory storage media having stored the game program according to claim 2, wherein
the in-game effect is an effect of allowing the second player object to advance the game advantageously.

4. The one or more computer-readable non-transitory storage media having stored the game program according to claim 3, wherein
the first state is such a state that will end up in game over or interrupt play to restart play, when the predetermined period elapses, and
the in-game effect is an effect of allowing the play to be continued.

5. The one or more computer-readable non-transitory storage media having stored the game program according to claim 2, wherein
the predetermined distance is less than a distance that the first player object can travel when continuously moving during the predetermined period.

6. The one or more computer-readable non-transitory storage media having stored the game program according to claim 2, wherein
the state icon includes information regarding a remaining time until the predetermined period elapses for the second player object.

7. The one or more computer-readable non-transitory storage media having stored the game program according to claim 2, wherein
the state icon includes information regarding a distance to the position of the second player object.

8. The one or more computer-readable non-transitory storage media having stored the game program according to claim 2, causing the one or more processors to, when the first player object is in the first state, generate, instead of the 2P icon or in addition to the 2P icon, distance information to the position of the second player object so that the distance information is displayed in the game image.

9. The one or more computer-readable non-transitory storage media having stored the game program according to claim 2, causing the one or more processors to perform control such that
in a case of not exceeding the predetermined distance, the 2P icon is reduced as a distance between the first player object and the second player object becomes longer, and
in a case of exceeding the predetermined distance, the 2P icon has a constant size irrespective of the distance between the first player object and the second player object.

10. The one or more computer-readable non-transitory storage media having stored the game program according to claim 2, causing the one or more processors to change a display manner of the 2P icon when a distance between the first player object and the second player object becomes greater than the predetermined distance.

11. The one or more computer-readable non-transitory storage media having stored the game program according to claim 1, causing the one or more processors to, when the second player object is in a second state, generate, instead of the 2P icon or in addition to the 2P icon, a specific state icon indicating the second state so that the specific state icon is displayed in the game image, irrespective of a distance between the first player object and the second player object.

12. The one or more computer-readable non-transitory storage media having stored the game program according to claim 11, wherein
the second state is such a state that the second player object disappears from the virtual space.

13. The one or more computer-readable non-transitory storage media having stored the game program according to claim 1, causing the one or more processors to change the second player object into the first state when the second player object acquires a predetermined item placed in the virtual space.

14. The one or more computer-readable non-transitory storage media having stored the game program according to claim 1, wherein
the virtual space includes an area where the second player object can move when being in the first state.

15. The one or more computer-readable non-transitory storage media having stored the game program according to claim 1, wherein
the game is such a game that the first player object is moved in a virtual course including a first virtual space and a second virtual space which are not continuously connected to each other, and
the game program causes the one or more processors to, when the first player object is in the first virtual space and the second player object is in the second virtual space, generate the 2P icon so that the 2P icon is displayed at a position that is in a game image for the first virtual space and that is according to a position of the second player object in the second virtual space.

16. The one or more computer-readable non-transitory storage media having stored the game program according to claim 15, wherein
the game is such a game that the game image is displayed such that the virtual space is side-scrolled or vertically scrolled,
a first predetermined range extending in a left-right direction or an up-down direction in the first virtual space, and a second predetermined range extending in a left-right direction or an up-down direction in the second virtual space, are set as associated ranges in advance, and
the game program causes the one or more processors to, when the second player object is present at a position included in the second predetermined range in the left-right direction or the up-down direction, generate the 2P icon so that the 2P icon is displayed at a position that is in the game image for the first virtual space and that is according to a position in the first predetermined range corresponding to a position in the second predetermined range based on the position of the second player object.

17. The one or more computer-readable non-transitory storage media having stored the game program according to claim 15, wherein
a relationship for associating a position in the second virtual space with a position in the first virtual space is set in advance, and
the game program causes the one or more processors to associate a position of the second player object in the second virtual space with a position in the first virtual space on the basis of the relationship, and generate the 2P icon so that the 2P icon is displayed at a position that is in the game image and according to the associated position in the first virtual space.

18. The one or more computer-readable non-transitory storage media having stored the game program according to claim 15, causing the one or more processors to, when the first player object and the second player object are present in different spaces, generate the 2P icon without generating the state icon even if the second player is in the first state.

19. A game processing method for causing one or more processors of a game system to:
move a first player object in a virtual space in accordance with an operation input by a player;
control a virtual camera for generating a game image, in association with a position of the first player object;
when a second player object operated by another player is present outside a range of the game image, generate a 2P icon indicating the second player object so that the 2P icon is displayed at a position that is in the game image and according to the position of the second player object; and
when the second player object is in a first state,
if a distance to the second player object from a reference position for the first player object is less than a predetermined distance, generate, instead of the 2P icon or in addition to the 2P icon, a state icon indicating the first state so that the state icon is displayed in the game image, and
if the distance to the position of the second player object is not less than the predetermined distance, generate the 2P icon so that the 2P icon is displayed at a position that is in the game image and according to a position of the second player object, without generating the state icon.

20. A processing system comprising one or more processors and one or more computer-readable non-transitory storage media having a game program stored therein, the processing system causing the one or more processors to, by the one or more processors executing the game program loaded in a memory:
move a first player object in a virtual space in accordance with an operation input by a player;
control a virtual camera for generating a game image, in association with a position of the first player object;
when a second player object operated by another player is present outside a range of the game image, generate a 2P icon indicating the second player object so that the 2P icon is displayed at a position that is in the game image and according to the position of the second player object; and
in generating the 2P icon, when the second player object is in a first state,
if a distance to the second player object from a reference position for the first player object is less than a predetermined distance, generate, instead of the 2P icon or in addition to the 2P icon, a state icon indicating the first state so that the state icon is displayed in the game image, and
if the distance to the position of the second player object is not less than the predetermined distance, generate the 2P icon so that the 2P icon is displayed at a position that is in the game image and according to a position of the second player object, without generating the state icon.
